(19) United States
(12) Patent Application Publication
(10) Pub. No.: US 2011/0097192 A1
(43) Pub. Date: Apr. 28, 2011

(54) Pyrometer with Spatial Resolution

(76) Inventors: Thomas Bosselmann, Marloffstein (DE); Stefan Maurer, Erlangen (DE); Michael Willsch, Jena (DE)

(21) Appl. No.: 12/933,123

(22) PCT Filed: Mar. 17, 2009
(86) PCT No.: PCT/EP2009/053141

§ 371 Date: Dec. 6, 2010

(30) Foreign Application Priority Data
Mar. 20, 2008 (DE) 102008015205.6

(51) Int. Cl. F04D 29/00; G02B 6/06

(52) U.S. Cl. 415/118; 250/227.2

(57) ABSTRACT

A pyrometer for gas turbines is provided. Incident thermal radiation is split between a plurality of optical wave guides by a reflection prism and a lens according to regions on the surface of a turbine blade. The pyrometer is built into the wall of the turbine without protruding and enables the simultaneous and parallel measurement of the temperature of a plurality of regions on the surface of the turbine blade when a spectrum of the heat radiation is largely maintained.

### CROSS REFERENCE TO RELATED APPLICATIONS

This application is the US National Stage of International Application No. PCT/EP2009/053141 filed Mar. 17, 2009, and claims the benefit thereof. The International Application claims the benefits of German Application No. 10 2008 015 205.6 DE filed Mar. 20, 2008. All of the applications are incorporated by reference herein in their entirety.

### FIELD OF INVENTION

The invention relates to an optical measuring device, especially for use in gas turbines.

### BACKGROUND OF INVENTION

Pyrometry is one option for determining the temperature of an object. It involves the detection and evaluation of heat radiation originating from the object. The spectrum of the heat radiation can be evaluated but the entire emitted power can also be evaluated. Pyrometry is especially advantageous with very hot objects since a contact measurement is rendered difficult here and on the other hand the heat radiation is very strong.

Thus this form of measurement is usually used to determine the temperature of turbine blades of gas turbines. These are at temperatures of typically 1200° C. and more. Future increases in the efficiency of gas turbines are coupled to an increase in the operating temperature. The demands on material properties of gas turbine blades will be increased by this. At the same time monitoring the temperature and the temperature distribution on the surface of the turbine blades is necessary in order to detect local overheating and enable destruction of the blades to be prevented.

The practice of determining the temperature at one location of the surface of the turbine blades using a pyrometer is known. The disadvantage of this is that no information can be provided about the temperature distribution on the surface. Carrying out so-called “traversing” is also known, i.e. moving the optical sensor into the turbine chamber for a short period. The disadvantage of this is, on the one hand that a mechanism is needed for the traversing and on the other that the sensor projects into the turbine chamber temporarily. The latter requirement demands that the sensor is highly robust because of the extremely high speeds involved and it also disturbs the gas flow and thereby the operation of the turbine.

Provision of a dispersive prism in the pyrometer is also known from U.S. Pat. No. 4,240,706. The prism allows different locations on the blade to be measured by a location selection being carried out on the basis of a wavelength selection. This solution requires filters however for the corresponding individual wavelengths and thus for the locations which are to be observed. Another disadvantage is that only one wavelength is ever visible from one location and thus much information, for example in the form of the spectrum, and power of the heat radiation gets lost. This has a disadvantageous effect on the accuracy of the measurement.

### SUMMARY OF INVENTION

An object of the present invention is to specify an optical measuring device which allows a parallel and simultaneous measurement or monitoring of a number of locations on an object, with the spectrum of the radiation arriving from the object being retained at least in parts for the locations at the same time.

This object is achieved by an optical measurement device as claimed in the independent claim. The dependent claims relate to advantageous embodiments and developments of the invention.

The inventive optical measurement device is designed to measure an object in a flow passage of a fluid, with the measurement being undertaken through walling of the flow passage. It features a mirror element for reflection of radiation arriving from the object. Furthermore the inventive optical measurement device features at least one imaging element for focusing at least one part of the radiation.

The advantageous result achieved by the elements of the inventive optical measurement device is that with the radiation, after its passage through the two elements for specific locations in the measurement device, a relationship exists between the respective location in the measurement device and the emission location of the radiation, i.e. the area on the surface of the object at which the radiation was emitted. At the same time however the radiation still consists of the full originally emitted spectrum, provided the material properties of the elements and other components through which the radiation must pass allow this. In any event no filtering to essentially one wavelength takes place. In the text below the spectrum within the measurement device, even if in parts it can be incomplete in relation to the originally emitted spectrum, is designated as complete.

Thus it is possible by means of selecting the radiation via its location in the optical measurement device, to observe, measure and monitor a number of areas of the surface of the object simultaneously and in parallel, whereby the full spectrum is available. At the same time the mirror element makes it possible advantageously for there to be no need for either a mechanical movement of the measuring device or for such a movement within the measuring device. Instead the measuring device can for example be provided offset laterally to a degree from the surface to be observed, with the mirror element insuring a suitable deflection of the radiation.

The optical measurement device can be used for example for pyrometric measurement of the temperature of the emission locations on the object. In this case the radiation is emitted from the material of the object itself. It is however just as possible to use the measurement device for receiving scattered or reflected light striking the areas.

Preferably in this case the mirror element is arranged first in the radiation path away from the object within the measurement device, so that the radiation only strikes the imaging element after passing through the mirror element. As an alternative however there is also the option of arranging the elements the other way round in relation to the radiation so that this first strikes the imaging element and then the mirror element.

In an especially advantageous embodiment of the invention the minor element involved is a reflection prism. The reflection prism has the advantage of being less susceptible to contamination of the surfaces since the actual reflecting surface lies in the prism material and cannot become contaminated. Furthermore the inner total reflection can be utilized with reflection prisms, which reduces the power losses during the reflection. It is especially advantageous for the reflection prism to consist of quartz glass since, in addition to its high temperature resistance, this only exhibits small inherent emissions of heat radiation. This improves the accuracy of the measurement. Sapphire can typically be considered as an alternate material. As an alternative it is possible to design the reflective element as a minor, especially as a metallic mirror.

In an embodiment of the invention the imaging element is designed as a perforated mask, which makes an especially simple structure possible. The use of one or more lenses as imaging elements is advantageous. It is especially advantageous to use an aspherical lens since a precise optical imaging of the radiation from a wide area of emission locations on the object is possible with this method. This results in a high measurement accuracy.

In an especially advantageous embodiment and development of the invention the optical measurement device features two, three, . . . , seven or more optical waveguides connected to the elements. The optical waveguides are used for passing on the radiation after the mirror and the imaging element, to one or more detectors for example. This means that with the beginning of the optical waveguides the guiding of the radiation is independent of the further geometrical structure of the measurement device. The closer the end of the optical waveguides is to the elements of the measurement device, the smaller are the losses through beam divergence.

The result achieved by the minor element and the imaging element is that each of the optical waveguides accepts radiation from a respective area on the surface of the object and passes it on. The locations of the areas and their size are determined in such cases via the mirror and the imaging element as well as by the location of the end of the respective optical waveguide. In particular the areas can be placed so that an extensive part of the object is detected. In particular it is possible in such cases for the areas to overlap or not overlap.

The imaging element is embodied in a development of the invention as a part of the optical waveguide. To this end the optical waveguides typically have an integrated lens at their end in the measurement device in each case. This can for example be realized using a micro-structuring of the end of the optical waveguide or can be created by a melting process. This embodiment makes the structure very flexible. For a greater accuracy in the imaging it is also possible to use one or more lenses as the imaging element in conjunction with the lenses integrated into the optical waveguides.

In an advantageous embodiment and development of the invention the optical measurement device has a window to close it off in relation to the fluid. The window, through the expedient tight seal in relation to the fluid, protects the inside of the measurement device, especially the elements already described. It is expedient for the window to be transparent at least for a part of the respective spectrum of the radiation emitted by the object. The window can typically involve a quartz glass, plastic or also sapphire window.

The optical measurement device can advantageously be used one or more times in a turbine, for example a gas turbine. Because of the high temperatures in the gas turbine the use for pyrometric temperature measurement at the turbine blades is especially advantageous. The measurement device is also usable in other turbine types and for other fluid types, for example liquids, and other temperatures. It is also conceivable to use the measurement device not for recording emitted heat radiation but for measurement via diffuse or mirrored reflection, in which the radiation is thus not emitted by the object itself or by the objects themselves.

Specifically in the case of turbines, especially gas turbines, it is advantageous for the optical measurement device to be built in such that it, i.e. if necessary the sealing window, makes a smooth wall seal with the turbine walling, since a disruption of the fluid flow is avoided in this way and when closed off by a window, it is also only the window that is subjected to the conditions in the turbine.

### BRIEF DESCRIPTION OF THE DRAWINGS

Further advantages and details of the invention will be explained below on the basis of an exemplary embodiment shown in the drawing. The figures show the following schematic diagrams:

FIG. 1 an optical measurement device

FIG. 2 the measurement device in a turbine, viewed from the side of the turbine

FIG. 3 the measurement device in a turbine, viewed from above.

### DETAILED DESCRIPTION OF INVENTION

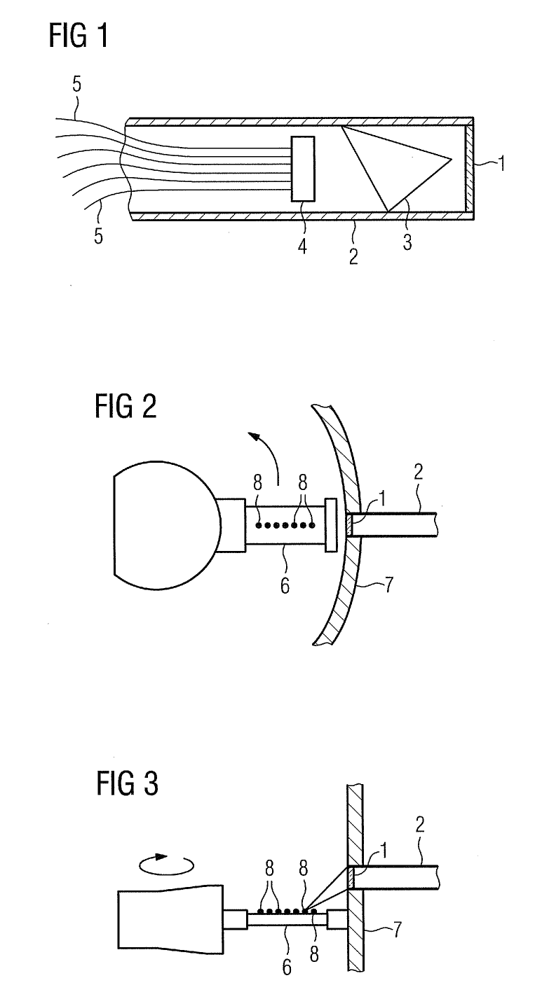

In the possible form of embodiment of the invention in accordance with FIG. 1 the optical measurement device is realized in a tube 2. This tube 2 is suitable for example for use in a gas turbine, as is shown in FIGS. 2 and 3. The tube 2 is in the form of a cylinder and typically has a length of 7 cm and an outer diameter of 1 cm. It is expedient for the tube 2 to be designed for use in a gas turbine such that it withstands the temperatures occurring there.

The tube 2 is closed off on the turbine side by a sapphire window 1. This is especially temperature-stable and is essentially transparent for the heat radiation occurring which is to be recorded by the measurement device for determining the temperature. At the same time the sapphire window 1 prevents the penetration of hot gas into the tube 2 and thus protects the further components.

In the area behind the sapphire window 1 is arranged a reflection prism 3. The reflection prism 3 deflects the incoming radiation without breaking it down into its spectral components. After the deflection the radiation strikes a lens 4. This focuses the radiation such that light originating from different areas 8 of a turbine blade which are typically shown in FIGS. 2 and 3, is directed in each case to one of for example seven glass fibers 5 provided. The glass fibers 5 guide the radiation onwards into detectors which allow an evaluation of the incoming spectrum or the incoming amount of light.

FIG. 2 shows a schematic sectional diagram viewed from the side of a turbine with a turbine blade 6. FIG. 3 shows a schematic sectional diagram from above of the turbine. Areas 8 are indicated on the turbine blade 6 of which the temperature is to be monitored in parallel over time with the optical measurement device in accordance with FIG. 1. To this end the measurement device is built in pointing radially onto the turbine hub but offset laterally to the turbine blade 6, as can be seen from FIGS. 2 and 3.

The heat radiation from the turbine blade 6 striking the sapphire window 1 at an angle is indicated by the light paths in FIG. 3. The radiation is deflected by the reflection prism 3 in the tube 2 and distributed through the lens 4, as already described for FIG. 1, into the seven glass fibers 5. Each glass fiber then only carries heat radiation from a specific area B. This makes it possible, during the possible rapid preheating of the turbine blade 6 to undertake a parallel temperature measurement in the seven areas.

1.-8. (canceled)

9. An optical measuring device for measuring an object in a flow passage of a fluid, the measurement being undertaken through walling of the flow passage, comprising:
a mirror element for diverting radiation arriving from the object;
at least one imaging element for focusing at least one part of the radiation; and
optical waveguides arranged adjacent to the mirror element and the at least one imaging element for passing on the radiation.

10. The optical measurement device as claimed in claim 9, wherein the mirror element is a reflection prism.

11. The optical measurement device as claimed in claim 10, wherein the reflection prism comprises quartz glass.

12. The optical measurement device as claimed in claim 9, wherein the at least one imaging element is an aspherical lens.

13. The optical measurement device as claimed in claim 9, wherein the at least one imaging element is part of the optical waveguides such that the optical waveguides include an integrated lens at the end of the optical waveguides.

14. The optical measurement device as claimed in claim 9, wherein the at least one imaging element is part of the optical waveguides such that the optical waveguides include a micro-structuring at the end of the optical waveguides.

15. The optical measurement device as claimed in claim 9, further comprising:
a window for closing off the device in relation to the fluid.

16. A turbine with turbine blades, comprising:
an optical measurement device for measuring the turbine blades, the optical measurement device comprising:
a mirror element for diverting radiation arriving from a turbine blade;
at least one imaging element for focusing at least one part of the radiation; and
optical waveguides arranged adjacent to the mirror element and the at least one imaging element for passing on the radiation.

17. The turbine as claimed in claim 16, wherein the turbine is a gas turbine.

18. The turbine as claimed in claim 16, wherein the optical measuring device is built in the turbine such that the device has a smooth wall closure with a walling of the turbine.

19. The turbine as claimed in claim 16, wherein the mirror element of the optical measurement device is a reflection prism.

20. The turbine as claimed in claim 19, wherein the reflection prism comprises quartz glass.

21. The turbine as claimed in claim 16, wherein the at least one imaging element of the optical measurement device is an aspherical lens.

22. The turbine as claimed in claim 16, wherein the at least one imaging element is part of the optical waveguides such that the optical waveguides include an integrated lens at the end of the optical waveguides.

23. The turbine as claimed in claim 16, wherein the at least one imaging element is part of the optical waveguides such that the optical waveguides include a micro-structuring at the end of the optical waveguides.
